(19) United States
(12) Patent Application Publication
(10) Pub. No.: US 2007/0185644 A1
(43) Pub. Date: Aug. 9, 2007

(54) Navigation apparatus, computer program, screen displaying control method, and measurement interval control method

(75) Inventor: Koji Hirose, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; INCREMENT P CORPORATION

(21) Appl. No.: 11/595,884

(22) Filed: Nov. 13, 2006

(30) Foreign Application Priority Data
Nov. 11, 2005 (JP) P2005-328138

(51) Int. Cl. G01C 21/00

(52) U.S. Cl. 701/200; 701/211

(57) ABSTRACT

The present invention provides a navigation apparatus, a computer program and a screen control method that can reduce the amount of power to be consumed by screen display operations while information is properly displayed on the screen for a user. When the information to be provided to the user is displayed on the screen of a display device, a system control device determines whether the situation allows the driver to look at the screen of the display device, on the basis of vehicle moving conditions such as the vehicle speed, the traveling direction, and the angle of a turn of the steering wheel detected by a GPS receiving device and various sensors, or map data. If the system control device determines that the situation does not allow the driver to look at the screen, a display control device reduces the luminance of the screen of the display device.

### BACKGROUND OF THE INVENTION

1. Field of the Invention

The present invention relates to a navigation apparatus that guides a movable body through a route, and also relates to a computer program, a screen control method, and a measurement interval control method.

2. Description of the Related Art

As portable telephones have widely spread, recent developments have been made involving portable telephones that have sensors such as GPS (Global Positioning System) mounted thereon and function as mobile navigation apparatuses, and portable telephones that are installed in vehicles and function as car-mounted navigation apparatuses.

The electric driving force of such portable telephones can be obtained from in-vehicle batteries. However, when a portable telephone is used on the move, the electric driving force is obtained from a built-in battery such as a lithium-ion battery. Therefore, for a portable telephone to endure long-time mobile use, reducing the power consumption is critical when the portable telephone functions as a navigation apparatus.

Meanwhile, a regular car-mounted navigation apparatus might be used over a relatively long period of time. Therefore, when only a small amount of power remains in the in-vehicle battery, attention should be paid to the amount of power to be consumed.

To counter this problem, the power consumption by screen displaying operations can be reduced.

Conventionally, to reduce the power consumption, a screensaver is activated after a predetermined period of time has passed, or the display screen is switched off, or the screen is darkened, for example.

Japanese Patent Application Laid-Open No. 2004-101366 discloses a portable communication terminal that displays necessary map information when the distance between the current spot and a target spot is equal to or shorter than a predetermined distance, but does not display necessary map information when the distance exceeds the predetermined distance. With this arrangement, the power consumption of this portable communication terminal is made smaller than the power consumption of a conventional portable communication terminal that displays map information at all times.

In a navigating process, an arithmetic operation on the basis of output signals from various sensors is performed so as to detect (measure) the position of own vehicle. To increase the accuracy of the position detection, a measuring operation is performed at intervals shorter than a predetermined time, and the intervals are normally fixed (one-second intervals, for example). The power consumed in the arithmetic operation and the power consumed by the sensors constitute a significant fraction of the total power consumption.

To counter this problem, Japanese Patent Application Laid-Open No. 2002-81957 discloses a portable navigation apparatus that calculates an estimated time required for the subject body to reach a target object on the route to a destination. Before the estimated time has passed, the portable navigation apparatus does not determine whether the subject body (a pedestrian) overlaps the target object. After the estimated time has passed, the portable navigation apparatus performs the determining operation at predetermined time intervals. In this manner, the power consumption is made smaller than the power consumption of a portable navigation apparatus that constantly performs the determining operation.

However, the conventional operation such as the screensaver activating process is carried out, regardless of the intention of the user. As a result, the necessary information is not displayed on the screen, even when the user wishes to look at the information. This causes inconvenience to the user. On the other hand, when the user does not need to look at the screen, the screen display is maintained until a predetermined period of time has passed. As a result, the electric power is wasted.

In the portable communication terminal disclosed in Japanese Patent Application Laid-Open No. 2004-101366, the screen display is also switched on and off in accordance with the distance to the target spot or the time required to reach the target spot, regardless of the intention of the user. As a result, the same problem as above is caused.

In the portable navigation apparatus disclosed in Japanese Patent Application Laid-Open No. 2002-81957, the determining operation is not performed before the estimated time for the subject body to reach the target object has passed. Therefore, in a case where the subject body runs past the target object before the estimated time has passed or where the subject body deviates from the route, the power consumption increases due to a re-determining operation performed after the estimated time has passed. In addition, the determining operation performed beforehand is wasted.

### SUMMARY OF THE INVENTION

The present invention has been developed, with the above problems being taken into account. An object of the invention is to provide a navigation apparatus, a computer program, and a screen control method that can reduce the amount of power to be consumed by screen displaying operations while information is properly displayed on the screen for the user.

Another object of the invention is to provide a navigation apparatus, a computer program, and a measurement interval control method that can reduce the amount of power to be consumed by measuring operations while the current position of the subject movable body is properly measured in accordance with the movement condition of the subject movable body.

The above objects of the present invention can be achieved by a navigation apparatus. The navigation apparatus comprising: a detecting device that detects a movement condition of a movable body, the navigation apparatus displaying information for guiding the movable body through a route, on the basis of the detected movement condition and map data, the information being displayed on a screen; a determining device that determines whether the current situation allows an operator to look at the screen, on the basis of at least one of the detected movement condition and the map data; and a screen controlling device that reduces luminance of the screen or blackout the screen, when the determining device determines that the current situation does not allow the operator to look at the screen.

The above objects of the present invention can be achieved by a computer program. The computer program embodied in a computer-readable medium and representing a sequence of instructions, which when executed by a computer included in a navigation apparatus that includes a detecting device that detects a movement condition of a movable body, and displays information for guiding the movable body through a route, on the basis of the detected movement condition and map data, the information being displayed on a screen, the instructions cause the computer to function as: a determining device that determines whether the current situation allows an operator to look at the screen, on the basis of at least one of the detected movement condition and the map data; and a screen controlling device that reduces luminance of the screen or blackout the screen, when the determining device determines that the current situation does not allow the operator to look at the screen.

The above objects of the present invention can be achieved by a method for controlling a screen in a navigation apparatus. the method for controlling a screen in a navigation apparatus that includes a detecting device that detects a movement condition of a movable body, and displays information for guiding the movable body through a route, on the basis of the detected movement condition and map data, the information being displayed on the screen, the method comprising: a determining process of determining whether the current situation allows an operator to look at the screen, on the basis of at least one of the detected movement condition and the map data; and a reducing process of reducing luminance of the screen or erasing the displayed information on the screen, when the current situation does not allow the operator to look at the screen.

The above objects of the present invention can be achieved by a navigation apparatus. The navigation apparatus comprising: a speed detecting device that detects a movement speed of a movable body and outputs speed data; a condition detecting device that detects a movement condition of the movable body except for the movement speed, and outputs condition data; a measuring device that measures the current position of the movable body, on the basis of the output speed data and the output condition data; and a measurement interval controlling device that controls a measurement interval of the measuring device in such a manner that the measurement interval becomes longer as the movement speed represented by the output speed data becomes lower, the navigation apparatus guiding the movable body through a route, on the basis of the movement condition and the current position of the movable body, and map data.

The above objects of the present invention can be achieved by a computer program. The computer program embodied in a computer-readable medium and representing a sequence of instructions, which when executed by a computer included in a navigation apparatus that includes: a speed detecting device that detects a movement speed of a movable body and outputs speed data; a condition detecting device that detects a movement condition of the movable body except for the movement speed, and outputs condition data; and a measuring device that measures the current position of the movable body, on the basis of the output speed data and the output condition data, the navigation apparatus guiding the movable body through a route, on the basis of the movement condition and the current position of the movable body, and map data, the instructions cause the computer to function as a measurement interval controlling device that controls a measurement interval of the measuring device in such a manner that the measurement interval becomes longer as the movement speed represented by the output speed data becomes lower.

The above objects of the present invention can be achieved by a method for controlling a measurement interval. The method for controlling a measurement interval in a navigation apparatus that includes: a speed detecting device that detects a movement speed of a movable body and outputs speed data; a condition detecting device that detects a movement condition of the movable body except for the movement speed, and outputs condition data; and a measuring device that measures the current position of the movable body, on the basis of the output speed data and the output condition data, the navigation apparatus guiding the movable body through a route, on the basis of the movement condition and the current position of the movable body, and map data, the method comprising a controlling process of controlling the measurement interval of the measuring device in such a manner that the measurement interval becomes longer as the movement speed represented by the output speed data becomes lower.

### BRIEF DESCRIPTION OF THE DRAWINGS

FIG. 1 is a block diagram showing an example structure of a navigation apparatus according to a first embodiment of the present invention;

FIG. 2 is a flowchart showing an example operation to be performed by the navigation apparatus according to the first embodiment;

FIG. 3 shows an example of a screen controlling operation according to the first embodiment;

FIGS. 4A through 4C show other examples of screen controlling operations according to the first embodiment;

FIG. 5 is a block diagram showing an example structure of a navigation system according to a modification of the first embodiment;

FIG. 6 is a block diagram showing an example structure of a navigation apparatus according to a second embodiment of the present invention;

FIG. 7 is a flowchart showing an example operation to be performed by the navigation apparatus according to the second embodiment;

FIG. 8 is a flowchart showing an example operation to be performed by a navigation apparatus according to a first modification of the second embodiment;

FIG. 9 shows examples of position measurement intervals according to the first modification of the second embodiment; and

FIG. 10 is a block diagram showing an example structure of a navigation system according to a second modification of the second embodiment.

### DESCRIPTION OF THE PREFERRED EMBODIMENTS

The following is a description of preferred embodiments of the present invention, with reference to the accompanying drawings. In the following embodiments, the present invention is applied to car-mounted navigation apparatuses.

### 1. First Embodiment

1.1 Structure and Functions of Navigation Apparatus 100

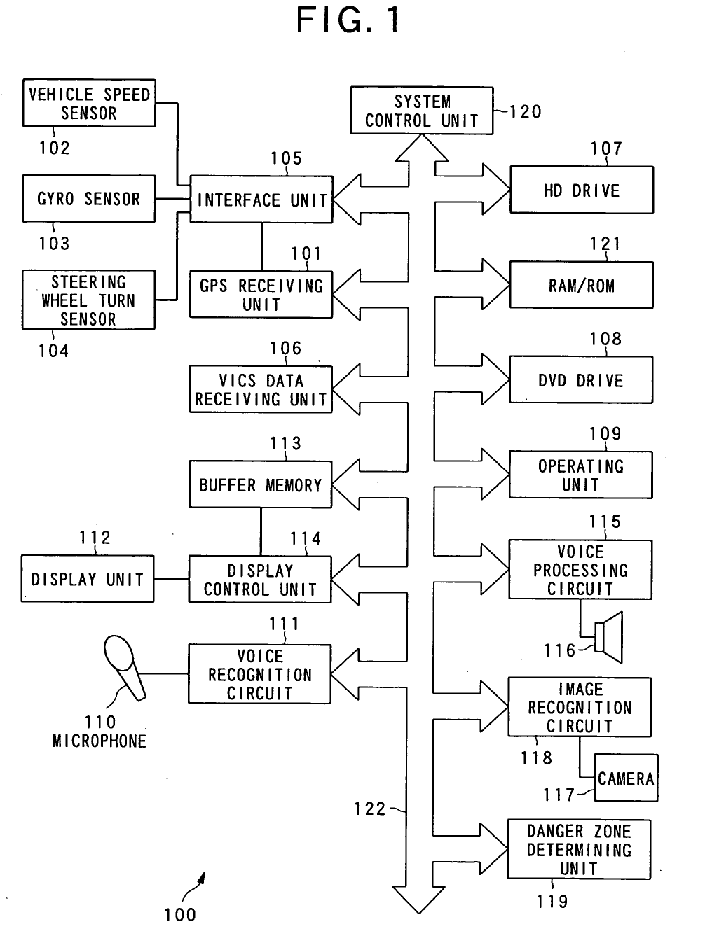

Referring first to FIG. 1, the structure and functions of a navigation apparatus 100 according to a first embodiment of the present invention are described.

FIG. 1 is a block diagram showing an example structure of the navigation apparatus 100 according to the first embodiment.

The navigation apparatus 100 according to this embodiment displays information for guiding a user to a destination that is set by the driver (an example of an operator) or a fellow passenger (a user) on its screen. In this navigation apparatus 100, the luminance of the screen is reduced according to the situation, so as to reduce the power consumption by the screen display.

As shown in FIG. 1, the navigation apparatus 100 according to this embodiment includes: a GPS receiving unit 101 that receives GPS data; a vehicle speed sensor 102 that detects vehicle speed data indicating the traveling speed of the vehicle; a gyro sensor 103 that detects azimuth data indicating the traveling direction of the vehicle; a steering wheel turn sensor 104 that detects turn angle data indicating the angle of a turn of the steering wheel; an interface unit 105 that calculates the position of own vehicle, on the basis of the GPS data, the vehicle speed data, and the azimuth data; a VICS data receiving unit 106 that receives Vehicle Information Communication System data; an HD drive 107 that performs data writing and reading on an HD (Hard Disk) storing various kinds of data such as map data; a DVD drive 108 that reads data from a DVD (Digital Versatile Disk); an operating unit 109 that is used by the user to input an instruction to the system; a microphone 110 that collects the voice of the user; a voice recognition circuit 111 that recognizes the instruction input to the system on the basis of the sound collected by the microphone 110; a display unit 112 that displays data such as map data and the position of the vehicle; a display control unit 114 that controls the display unit 112, using a buffer memory 113; a voice processing circuit 115 that generates sound for route guidance or the like; a speaker 116 that outputs acoustic waves of audio frequencies; a camera 117 that picks up an image of the driver; an image recognition circuit 118 that recognizes which direction the driver is looking, on the basis of the image taken by the camera 117; a danger zone determining unit 119 that determines whether own vehicle is located in a danger zone, on the basis of the position of own vehicle and the map data; a system control unit 120 that controls the entire system; and a RAM (Random Access Memory)/ROM (Read Only Memory) 121. The system control unit 120 and the other components are connected via a system bus 122.

The vehicle speed sensor 102 forms an example of the speed detecting unit of the present invention. The gyro sensor 103 forms an example of the direction detecting unit of the invention. The steering wheel turn sensor 104 forms an example of the operated amount detecting unit of the invention. The interface unit 105 forms an example of the measuring unit of the invention. The danger zone determining unit 119 forms an example of the spot data acquiring unit of the invention. The system control unit 120 forms an example of the screen controlling unit of the invention.

Further, the GPS receiving unit 101, the vehicle speed sensor 102, the gyro sensor 103, and the steering wheel turn sensor 104 form an example of the detecting unit of the invention. The danger zone determining unit 119 and the system control unit 120 form an example of the determining unit of the invention.

The GPS receiving unit 101 receives electric waves containing satellite orbit data and time data that are transmitted from a GPS satellite. The GPS receiving unit 101 calculates the current position of the subject movable body on the basis of the received electric waves, and outputs the current position as GPS data to the interface unit 105.

The vehicle speed sensor 102 detects the traveling speed of the vehicle. The vehicle speed sensor 102 also converts the detected speed to a voltage or the like, and outputs the voltage as vehicle speed data (an example of the speed data of the present invention) to the interface unit 105.

The gyro sensor 103 detects the azimuth of the vehicle. The gyro sensor 103 then converts the detected azimuth to a voltage or the like, and outputs the voltage as azimuth data (an example of the direction data of the present invention) to the interface unit 105.

The steering wheel turn sensor 104 detects the angle of a turn of the steering wheel. The steering wheel turn sensor 104 then converts the detected angle to a voltage or the like, and outputs the voltage as turn angle data (an example of the operated amount data of the present invention) to the interface unit 105.

The interface unit 105 performs interface operations between the system control unit 120 and the GPS receiving unit 101, the vehicle speed sensor 102, the gyro sensor 103, and the steering wheel turn sensor 104. The interface unit 105 receives GPS data, vehicle speed data, and azimuth data at regular intervals. On the basis of those data, the interface unit 105 calculates the position of own vehicle, and outputs the position as own vehicle position data to the system control unit 120.

The VICS data receiving unit 106 receives electric waves such as FM multiple broadcasting, to acquire VICS data that is road traffic information relating to traffic congestion, necessary amounts of time, accidents, speed limits, and likes. The VICS data receiving unit 106 then outputs the VICS data to the system control unit 120.

The HD drive 107 comprises an HD and a drive or the like that performs recording on the HD and reproducing of the HD. The HD drive 107 reads map data or the like stored in the HD, and outputs the data to the system control unit 120. The HD drive 107 also writes various kinds of data output from the system control unit 120 onto the HD.

The map data is associated with road shape data that is necessary for navigating operations, and the road shape data is associated with various kinds of relevant data such as relevant facility data and name data.

The DVD drive 108 comprises a housing unit that detachably houses a DVD, and a drive or the like that performs reproducing of the DVD. The DVD drive 108 reads map data for updating from the DVD disk, and outputs the read map data to the system control unit 120.

The DVD drive 108 reproduces the DVD disk on which content data such as audio data and video data recorded. The DVD drive 108 then outputs the reproduced content data or the like to the display control unit 114 and the voice processing circuit 115 via the system control unit 120.

The operating unit 109 comprises a remote control device or the like that has various keys such as setup keys, numeric keys, and cursor keys. In response to an input operation by the user, the operating unit 109 outputs a control signal to the system control unit 120.

The voice recognition circuit 111 analyzes speech voice that is input through the microphone 110 and is generated from the user. The voice recognition circuit 111 then recognizes the operation command from the user, and outputs the control signal for the recognized operation to the system control unit 120.

The display unit 112 comprises a liquid crystal panel, an organic EL (Electro Luminescence) panel, or the like. Under the control of the display control unit 114, the display unit 112 displays map data or the like on its screen, and also has various kinds of information such as the position of own vehicle that are necessary for route guidance. The necessary information is superimposed on the map data and the like, and is displayed on the screen.

On the basis of the map data and the content data that are input through the system control unit 120, the display control unit 114 generates image data in accordance with the data that is input under the control of the system control unit 120, and stores the image data in the buffer memory 113. The display control unit 114 also reads the image data from the buffer memory 113 in predetermined timing, and outputs the image data to the display unit 112.

Under the control of the system control unit 120, the display control unit 114 switches “on” and “off” the screen of the display unit 112 (in practice, the display control unit 114 increases or decreases the luminance of the screen).

More specifically, in a case where a liquid crystal panel is used for the display unit 112, for example, electric power is supplied to the backlight of the panel, so as to switch on the screen. To switch off the screen, the electric power supply to the backlight is stopped. It is also possible to switch on the screen by increasing the voltage in the power supply to the backlight, and to switch off the screen by decreasing the voltage.

In a case where an organic EL panel is used for the display unit 112, for example, the voltage to be supplied to the light emitting body is increased, so as to switch on the screen. To switch off the screen, the voltage to be supplied to the light emitting body is reduced.

The electric power supply to the display unit 112 may be stopped to blackout the screen and to switch off the screen.

Under the control of the system control unit 120, the voice processing circuit 115 generates and amplifies audio signals. The voice processing circuit 115 then outputs the audio signals to the speaker 116. As the audio signals, information relating to route guiding containing the traveling direction of the vehicle at the next intersection and traffic information such as the congestion levels and the existence of a closure are output from the voice processing circuit 115.

The camera 117 comprises a lens, a CCD (Charge Coupled Device), or the like. The CCD receives light from the outside, and, on the basis of a voltage signal according to the amount of received light, the camera 117 generates video data and outputs the video data to the image recognition circuit 118. The camera 117 is used to pick up images of the face of the driver, which are to be used to determine whether the driver is looking at the screen of the display unit 112. Therefore, the camera 117 should preferably be set in the vicinity of the center of the upper portion or the lower portion of the display unit 112, so that the lens is directed to the face of the driver.

The image recognition circuit 118 analyzes the video data that is output from the camera 117, so as to recognize the face and the eyes of the driver. The image recognition circuit 118 then generates sight line data according to the direction angle of the sight line of the driver with respect to the camera 117 (also the direction angle with respect to the screen of the display unit 112), and outputs the sight line data to the system control unit 120.

More specifically, the image recognition circuit 118 calculates which way the driver is looking, and also calculates the direction of the sight line with respect to the front face, on the basis of the positions of the pupils relative to the white portions of the eyes of the driver. Alternatively, the way the face of the driver is directed may be set as the direction of the sight line.

The danger zone determining unit 119 receives the own vehicle position data and the map data through the system control unit 120. On the basis of those data, the danger zone determining unit 119 determines whether the vehicle is currently located in a danger zone, and outputs the determination result as a control signal to the system control unit 120.

More specifically, the danger zone determining unit 119 obtains relevant data associated with the road or the like at which the vehicle is currently located (an example of the spot data of the present invention) from the map data. If the obtained relevant data contains information relating to locations such as a school road or a spot at which accidents have frequently occurred, the danger zone determining unit 119 determines that the vehicle is currently in a danger zone in which the driver should not look at the screen of the display unit 112, so as to ensure safe driving.

The danger zone determining unit 119 also obtains relevant data as to a spot 100 meters ahead along the traveling route of the vehicle, for example. On the basis of the obtained relevant data, the danger zone determining unit 119 determines whether the spot 100 meters ahead is in a danger zone, and outputs the determination result as a control signal to the system control unit 120.

The system control unit 120 mainly comprises a CPU (Central Processing Unit), and includes various input/output ports such as a GPS receiving port and a key input port.

The system control unit 120 is designed to control the entire navigation apparatus 100. The system control unit 120 reads a control program stored in the RAM/ROM 21, and performs various operations. The system control unit 120 also temporarily stores data being processed in the RAM/ROM 21.

For example, when performing a route guiding operation, the system control unit 120 performs a correcting operation such as map matching on the basis of the own vehicle position data that is output from the interface unit 105 and the map data that is read from the HD by controlling the HD drive 107. The system control unit 120 then controls the display unit 112 to display the route guiding information on the map showing the surrounding region including the current position of the vehicle, and controls the voice processing circuit 115 to output the route guiding information in the form of sound.

The system control unit 120 is also designed to determine whether to cause the display control unit 114 to switch on the screen of the display unit 112, on the basis of the vehicle speed data, the turn angle data, the GPS data, the map data, and the control signals output from the danger zone determining unit 119.

According to the criteria for judgment, when the driver can look at the screen of the display unit 112, the display control unit 114 switches on the screen, but when the driver should not look at the screen and must concentrate on driving, the display control unit 114 switches off the screen. The criteria for judgment will be described later in greater detail.

Further, in a case where the spot located 100 meters ahead along the traveling route is determined to be a danger zone on the basis of the control signal from the danger zone determining unit 119, the system control unit 120 controls the display unit 112 to display information that warns the driver about the danger zone ahead before the vehicle reaches the spot.

[1.2 Operations of Navigation Apparatus 100]

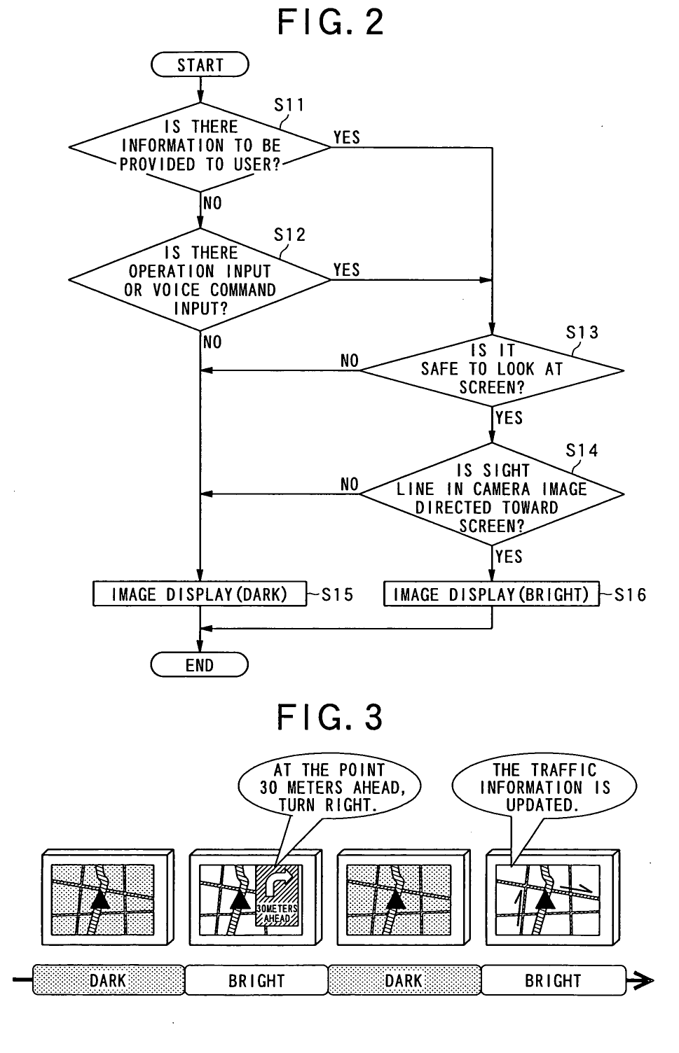

Referring now to FIGS. 2 through 4C, the operations to be performed in a case where the screen of the display unit 112 is switched on and off in the navigation apparatus 100 having the above described structure are described.

FIG. 2 is a flowchart showing an example operation to be performed in the navigation apparatus 100 according to the first embodiment.

As shown in FIG. 2, on the basis of the position data output from the interface unit 105, the map data of the surrounding region including the current position of the vehicle indicated by the position data, and the VICS data output from the VICS data receiving unit 106, the system control unit 120 first determines whether there is information to be displayed on the screen of the display unit 112 and provided to the user, such as information relating to the guidance of the traveling direction of the vehicle at an intersection and updated traffic information (step S11). If there is information to be provided (“YES” in step S11), the process moves on to step S13. If there is no information to be provided (“NO” in step S11), the process moves on to step S12.

In step S12, the system control unit 120 determines whether there is an operation and an audio operating command that are input by the user via the operating unit 109 and the voice recognition circuit 111. If there is an input (“YES” in step S12), the process moves on to step S13. If there is not an input (“NO” in step S12), the process moves on to step S16.

In step S13, the system control unit 120 determines whether the current situation is safe enough for the driver to look at the screen of the display unit 112.

More specifically, on the basis of the vehicle speed data that is output from the interface unit 105, the system control unit 120 determines that the driver can look at the screen if the traveling speed of the vehicle is less than 60 km/h, for example. If the traveling speed of the vehicle is 60 km/h or higher, the system control unit 120 determines that the driver should not look at the screen. The traveling speed of the vehicle may be calculated on the basis of the changes in the GPS data output from the interface unit 105 with time.

The system control unit 120 also determines that the driver can look at the screen if the angle of the turn of the steering wheel is less than 45 degrees, on the basis of the turn angle data that is output from the interface unit 105. If the angle of the turn of the steering wheel is 45 degrees or greater, the system control unit 120 determines that the driver should not look at the screen. If the angle of the turn of the vehicle is greater than a predetermined angle, the vehicle is presumably making a turn at an intersection, taking a sharp curve, or backing the vehicle into a garage. Therefore, if the angle of the turn of the steering wheel is greater than the predetermined angle, the system control unit 120 determines that the driver should not look at the screen. Alternatively, on the basis of changes with time in azimuth data output from the interface unit 105, the system control unit 120 may perform the same determining operation as above by comparing the angular speed of the vehicle taking a turn with a predetermined threshold value.

The system control unit 120 also controls the danger zone determining unit 119 to determine whether the vehicle is located in a danger zone. If the vehicle is determined not to be currently located in a danger zone on the basis of the control signal that is output from the danger zone determining unit 119, the system control unit 120 determines that the driver can look at the screen. If the vehicle is determined to be currently located in a danger zone, the system control unit 120 determines that the driver should not look at the screen.

If all the determination results indicate that the situation is safe enough for the driver to look at the screen (“YES” in step S13), the process moves on to step S14. If one or more of the determination results indicate that the situation prohibits the driver from looking at the screen (“NO” in step S13), the process moves on to step S16.

In step S14, on the basis of the control signal that is output from the image recognition circuit 118, the system control unit 120 determines whether the sight line of the driver is directed toward the screen (or the lens of the camera 117) (step S14). If the sight line is directed toward the screen (“YES” in step S14), the system control unit 120 controls the display control unit 114 to switch on the screen of the display unit 112, so that the screen of the display unit 112 becomes brighter (step S16).

If the sight line is not directed toward the screen (“NO” in step S14), the process moves on to step S15. In step S15, the system control unit 120 controls the display control unit 114 to switch off the screen of the display unit 112, so that the screen of the display unit 112 becomes darker (step S15).

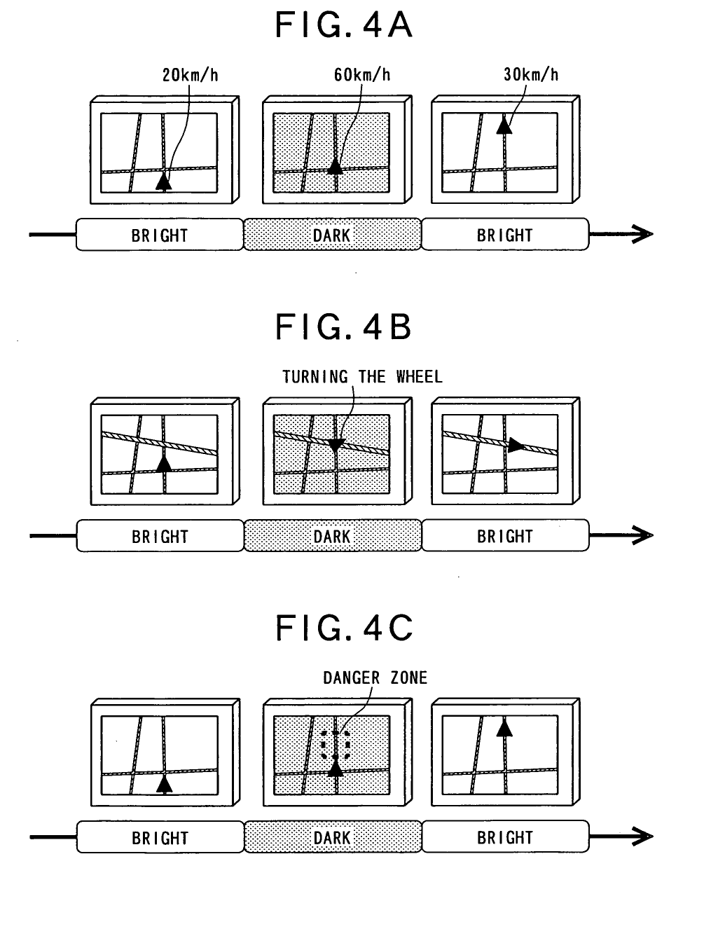

The above operation is now described in greater detail. FIG. 3 shows an example of a screen controlling operation according to the first embodiment. FIGS. 4A through 4C show other examples of screen controlling operations according to the first embodiment.

If there is no information to be provided to the user (“NO” in step S11) and there is not an operation input by the user (“NO” in step S12), there is no need to maintain the screen bright.

If there is information to be provided to the user (“YES” in step S11), the information is displayed on the screen. If there is an operation input by the user (“YES” in step S12), the information indicating the details of the operation is displayed on the screen. In such situations, there is a high probability that the driver stares at the screen. Therefore, it is preferable to make the screen bright.

If the situation prohibits the driver from looking at the screen for safety reasons (“NO” in step S13), the driver should not stare at the screen. Therefore, the screen is darkened.

In practice, if the driver is not looking at the screen (“NO” in step S14), there is no need to keep the screen bright.

The screen is made brighter when all the above conditions are satisfied.

For example, as shown in FIG. 3, if there is no information to be provided to the user (no operation inputs either), the screen is darkened. When the guiding information relating to the traveling direction of the vehicle at the next intersection is displayed (when the situation is safe and the driver is looking at the screen), the screen is made brighter. When the display of the guiding information is ended, the screen is darkened again. When updated congestion information is displayed on the screen, the screen is made brighter again.

When the vehicle speed is 20 km/h, the screen is made brighter (if there is information to be provided to the user and there is an operation input, which will be the necessary conditions in the examples described below), as shown in FIG. 4A. When the vehicle speed is 60 km/h, the screen is darkened. When the vehicle speed decreases to 30 km/h, the screen is made brighter again.

As shown in FIG. 4B, when the vehicle is moving straight, the screen is made brighter. When the steering wheel is operated to make a turn at an intersection, the screen is darkened. After the turn at the intersection, the screen is made brighter.

As shown in FIG. 4C, when the vehicle enters a danger zone, the screen is darkened. When the vehicle comes out of the danger zone, the screen is made brighter.

As described above, according to this embodiment, when information to be provided to the user is displayed on the screen of the display unit 112, the system control unit 120 determines whether the current situation allows the driver to look at the screen of the display unit 112, on the basis of the traveling conditions of the vehicle such as the vehicle speed, the traveling direction, and the turn angle of the steering wheel detected by the sensors 102 through 104, and the map data. When determining that the situation prohibits the driver from looking at the screen, the system control unit 120 controls the display control unit 114 to reduce the luminance of the screen of the display unit 112.

Accordingly, the power consumption by the screen display can be reduced, while information is properly displayed on the screen for the user.

If the traveling speed is 60 km/h or higher on the basis of the vehicle speed data that is output from the vehicle speed sensor 102, for example, the system control unit 120 also determines that the situation prohibits the driver from looking at the screen.

If the angle of the turn of the steering wheel is 45 degrees or greater on the basis of the turn angle data that is output from the steering wheel turn sensor 104, for example, the system control unit 120 also determines that the situation prohibits the driver from looking at the screen.

Further, the danger zone determining unit 119 determines whether the vehicle is currently located in a danger zone, on the basis of the position data and the map data that are output from the interface unit 105. On the basis of the determination result of the danger zone determining unit 119, the system control unit 120 determines whether the current situation allows the driver to look at the screen.

As described above, when the situation is not safe enough for the driver to look at the screen, the screen is darkened to prevent the driver from staring at the screen. Thus, the safety level at the time of driving becomes higher.

If the danger zone determining unit 119 determines that the spot 100 meters ahead along the traveling route is in a danger zone, the system control unit 120 controls the display control unit 114 to cause the display unit 112 to display the information that warns the driver about the danger zone before the vehicle reaches the danger zone. Thus, the user can be informed of the existence of the danger zone before the vehicle enters the danger zone and the screen becomes dark.

In this embodiment, the screen is switched on and off by carrying out all the determinations on the basis of the vehicle speed data, the turn angle data, and the relevant data associated with the road and the like. However, the screen may be switched on and off on the basis of the result of one of the determinations.

[1.3 Modification]

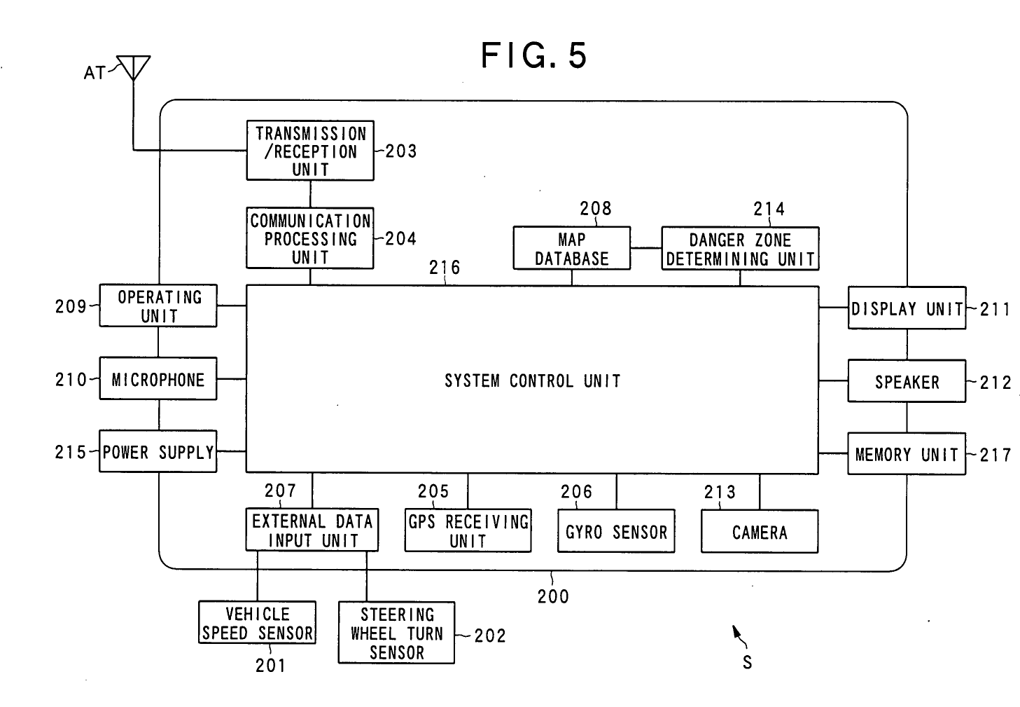

Referring now to FIG. 5, a modification of the first embodiment is described.

FIG. 5 is a block diagram showing an example structure of a navigation system S according to the modification of the first embodiment.

In the first embodiment described above, the present invention is applied to a car-mounted navigation system. However, it is also possible to apply the invention to a navigation system that utilizes a portable telephone.

In the navigation system according to this modification, each sensor is connected to a portable telephone that can communicate with other portable telephones by transmitting and receiving electric waves to and from the wireless base stations of a mobile communication network. The sensors and the portable telephone are installed in a vehicle, and serve as a car-mounted navigation system.

As shown in FIG. 5, the navigation system S includes a portable telephone 200, an external vehicle speed sensor 201 that detects vehicle speed data that indicates the traveling speed of the vehicle, and an external steering wheel turn sensor 202 that detects turn angle data that indicates the angle of a turn of the steering wheel.

The portable telephone 200 includes: a transmission/reception unit 203 that transmits and receives electric waves to and from the wireless base stations of the mobile communication network via an antenna AT; a communication processing unit 204 that modulates data to be transmitted and demodulates received data; a GPS receiving unit 205 that receives GPS data; a gyro sensor 206 that detects azimuth data indicating the traveling direction of the vehicle; an external data input unit 207 that receives data that is input from an external device; a map database 208 that stores map data; an operating unit 209 that is used by the user to input an instruction to the system; a microphone 210 that collects the voice of the user; a display unit 211 that displays data such as map data and the position of the vehicle; a speaker 212 that outputs acoustic waves of audio frequencies; a camera 213 that picks up an image of the driver; a danger zone determining unit 214 that determines whether own vehicle is located in a danger zone, on the basis of the position of own vehicle and the map data; a power supply 215; a system control unit 216 that controls the entire system; and memory unit 217 that includes memories such as a RAM and a ROM. The system control unit 216 and the other components are connected via a system bus.

The vehicle speed sensor 201 forms an example of the speed detecting unit of the present invention. The steering wheel turn sensor 202 forms an example of the operated amount detecting unit of the invention. The gyro sensor 206 forms an example of the direction detecting unit of the invention. The danger zone determining unit 214 forms an example of the spot data acquiring unit of the invention. The system control unit 216 forms examples of the determining unit, the screen controlling unit, and the measuring unit of the invention.

Further, the vehicle speed sensor 201, the steering wheel turn sensor 202, and the gyro sensor 206 form an example of the detecting unit of the invention.

The transmission/reception unit 203 receives electric waves such as communication signals and control signals transmitted from wireless base stations via the antenna AT. The transmission/reception unit 203 outputs the electric waves to the communication processing unit 204. The transmission/reception unit 203 also receives digital communication signals and the like that are output from the communication processing unit 204, and transmits those signals as electric waves to the wireless base stations.

The transmission/reception unit 203 also receives VICS data signals that are transmitted from the wireless base stations, and outputs the received VICS data signals to the communication processing unit 204.

The communication processing unit 204 demodulates the communication signals and the like that are output from the transmission/reception unit 203, and outputs the demodulated signals to the system control unit 216. The communication processing unit 204 also modulates communication signals and the like that are output from the system control unit 216, and outputs the modulated communication signals to the transmission/reception unit 203.

The external data input unit 207 A-D (Analog-Digital) converts the vehicle speed data and the turn angle data that are output from the vehicle speed sensor 201 and the steering wheel turn sensor 202. The external data input unit 207 then outputs the converted data to the system control unit 216.

The power supply 215 comprises a battery such as a lithium-ion battery. The power supply 215 supplies electric power while reducing the power supplied from the in-vehicle battery to a predetermined voltage. The power supply 215 also supplies the reduced power to the system control unit 216 and the other components.

The system control unit 216 mainly comprises a CPU, and has an integrated structure including various circuits such as a voice recognition circuit, a voice processing circuit, a display control circuit, and a buffer memory, and various input/output ports such as a GPS receiving port and a key input port.

The system control unit 216 is designed to control the entire navigation system S. The system control unit 216 reads a control program stored in the memory unit 217, and performs various operations. The system control unit 216 also temporarily stores data being processed in the memory unit 217.

The system control unit 216 generates an audio signal by performing format conversion, D-A conversion, amplification, and the like on communication data that is output from the communication processing unit 204. The system control unit 216 then outputs the audio signal to the speaker 212. The system control unit 216 also generates communication data by performing D-A conversion, format conversion, and the like on an audio signal that is output from the microphone 210. The system control unit 216 then outputs the communication data to the communication processing unit 204.

When a route guiding operation is performed, the system control unit 216 outputs information relating to the route guidance as an audio signal. The system control unit 216 also analyzes a speech of the user that is input through the microphone 210, and recognizes an operation command from the user.

Further, the system control unit 216 analyzes video data that is output from the camera 213, and calculates the direction angle of the sight line of the driver.

Further, the system control unit 216 calculates the position of own vehicle, on the basis of the GPS data that is output from the GPS receiving unit 205, the azimuth data that is output from the gyro sensor 206, and the vehicle speed data that is acquired through the external data input unit 207. The system control unit 216 then outputs the position of own vehicle as the own vehicle position data to the danger zone determining unit 214. The system control unit 216 also performs a correcting operation such as map matching on the basis of the position of own vehicle and the map data read from the map database. Information such as the route guiding information is then displayed on the display unit 211.

Furthermore, the system control unit 216 performs control operations to switch on and off the screen of the display unit 211.

The other aspects of the structure and the functions of this modification are the same as those of the navigation apparatus 100, and the operations of the navigation system S are also the same as those of the navigation apparatus 100. Therefore, explanation of them is not repeated herein.

### 2. Second Embodiment

[2.1 Structure and Functions of Navigation Apparatus 100a]

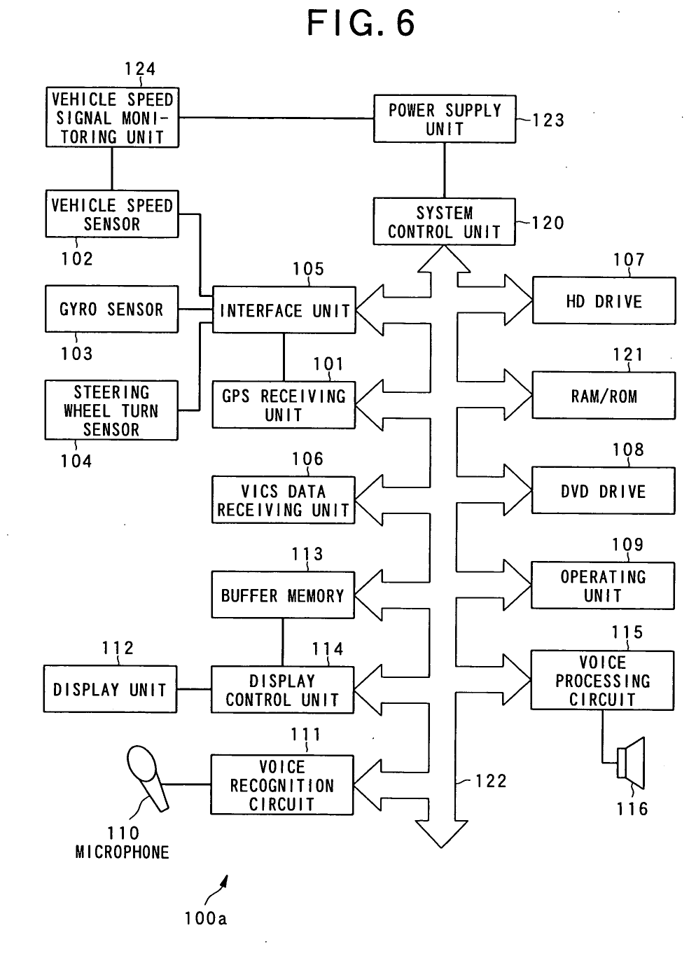

Referring now to FIG. 6, the structure and functions of a navigation apparatus 100a according to a second embodiment of the present invention are described.

FIG. 6 is a block diagram showing an example structure of the navigation apparatus 100a according to the second embodiment. In FIG. 6, the same components as those shown in FIG. 1 are denoted by the same reference numerals as those in FIG. 1.

To perform a route guiding operation for a destination that is set by the user, the navigation apparatus 100a according to this embodiment calculates (measures) the position of own vehicle, on the basis of the outputs of the respective sensors. The navigation apparatus 100a also lengthens the measurement interval, depending on the situation. By doing so, the navigation apparatus 100a reduces the power to be consumed by the position measuring operations.

As shown in FIG. 6, the navigation apparatus 100a according to this embodiment includes a GPS receiving unit 101, a vehicle speed sensor 102, a gyro sensor 103, a steering wheel turn sensor 104, an interface unit 105, a VICS data receiving unit 106, an HD drive 107, a DVD drive 108, an operating unit 109, a microphone 110, a voice recognition circuit 111, a display unit 112, a display control unit 114, a voice processing circuit 115, a speaker 116, a system control unit 120, and a RAM/ROM 121. The system control unit 120 and the other components are connected via a system bus 122.

The navigation apparatus 100a further includes a power supply unit 123 that supplies electric power to the system control unit 120 and the other components, and a vehicle speed signal monitoring unit that monitors outputs from the vehicle speed sensor 102.

The vehicle sensor 102 forms an example of the vehicle detecting unit of the present invention. The GPS receiving unit 101, the gyro sensor 103, and the steering wheel turn sensor 104 form an example of the status detecting unit of the invention. The interface unit 105 forms an example of the measuring unit of the invention. The VICS data receiving unit 106 forms an example of the traffic information acquiring unit of the invention. The system control unit 120 forms examples of the measurement interval controlling unit and the estimating unit of the invention.

Further, the system control unit 120 and the vehicle speed signal monitoring unit 124 form an example of the power controlling unit of the invention.

Under the control of the system control unit 120 and the vehicle speed signal monitoring unit 124, the power supply unit 123 reduces the power supplied from the in-vehicle battery to a predetermined voltage, and supplies the reduced voltage to the system control unit 120 and the other components.

On the basis of the vehicle speed data that is output from the vehicle speed sensor 102, the vehicle speed signal monitoring unit 124 performs a control operation to determine whether to start power supply from the power supply unit 123 to the respective components.

More specifically, the vehicle speed signal monitoring unit 124 outputs a control signal that represents a voltage change in the vehicle data at the time of the start of movement of the vehicle, to the power supply unit 123. The power supply unit 123 then starts supplying electric power.

The vehicle speed signal monitoring unit 124 may be formed by a circuit such as a comparator, or a microcontroller. The control operation described above may be performed by executing a predetermined control program.

The system control unit 120 according to this embodiment calculates the position measurement intervals, on the basis of the vehicle speed data that is output from the interface unit 105. The system control unit 120 then controls the interface unit 105 to perform a position measuring operation at the calculated position measurement intervals.

More specifically, when the speed of the vehicle is 40 km/h or higher, the system control unit 120 sets one-second measurement intervals (default). When the speed of the vehicle is 10 km/h to 40 km/h, the system control unit 120 sets 2-second measurement intervals. When the speed of the vehicle is 3 km/h to 10 km/h, the system control unit 120 sets 30-second measurement intervals. When the speed of the vehicle is 1 km/h to 3 km/h, the system control unit 120 sets 5-minute measurement intervals. When the speed of the vehicle is less than 1 km/h, the system control unit 120 sets 10-minute measurement intervals.

When the traveling speed is high, the traveling distance of the vehicle per unit time is long. Therefore, the position measurement intervals are shortened to cope with the changes in the vehicle movement conditions. When the traveling speed is low, the traveling distance of the vehicle per unit time is short. Accordingly, even if the position measurement intervals are lengthened, the changes in the vehicle movement conditions can be coped with.

When the measurement intervals are lengthened, the system control unit 120 updates the current position of the vehicle on the basis of only the vehicle speed data while the interface unit 105 is not performing a position measuring operation.

When determining that the vehicle has come to a halt on the basis of the vehicle speed data, the system control unit 120 outputs a control signal to the power supply unit 123, so as to stop the power supply from the power supply unit 123.

The other aspects of the structure and functions of this embodiment are the same as those of the first embodiment, and therefore, explanation of them is not repeated herein.

[2.2 Operations of Navigation Apparatus 100a]

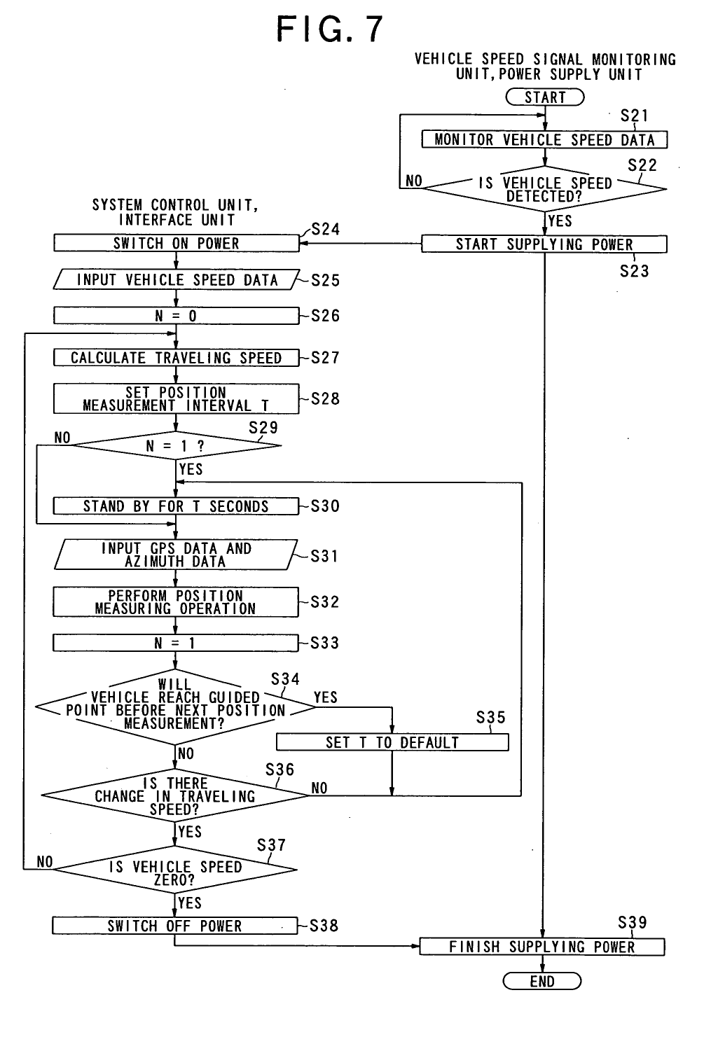

Referring now to FIG. 7, operations of the navigation apparatus 100a are described. FIG. 7 is a flowchart showing an example of an operation of the navigation apparatus 100a according to the second embodiment.

When the vehicle is in a stationary state, the vehicle speed signal monitoring unit 124 monitors the vehicle speed data that is output from the vehicle speed sensor 102, as shown in FIG. 7 (step S21).

The vehicle speed signal monitoring unit 124 then determines whether a vehicle speed is detected (step S22). If not a vehicle speed is detected (the vehicle is in a stationary state) (“NO” in step S22), the vehicle speed signal monitoring unit 124 continues to monitor the vehicle speed data (step S21). If a vehicle speed is detected (the vehicle starts moving) (“YES” in step S22), the vehicle speed signal monitoring unit 124 outputs a control signal to the power supply unit 123 so as to start supplying power to the respective components (step S23).

Receiving power supply from the power supply unit 123, the system control unit 120 starts executing the control program stored in the RAM/ROM 121 as the power source is turned on (step S24).

The system control unit 120 then starts receiving the vehicle data from the interface unit 105, and this input is performed at one-second intervals, for example (step S25).

After setting a flag N to “0” as the default (step S26), the system control unit 120 calculates the traveling speed of the vehicle, on the basis of the vehicle speed data (step S27). The system control unit 120 then sets a position measurement interval T (seconds) suitable for the traveling speed in the RAM/ROM 121 (step S28).

The system control unit 120 then determines whether the flag N is “1” (step S29). If the flag N is “1” (“YES” in step S29), the system control unit 120 stands by during the position measurement interval T (step S30). The interface unit 105 then inputs the GPS data and the azimuth data to the system control unit 120 (step S31), and performs a position measuring operation (step S32).

If the flag N is not “1” (“NO” in step S29), a position measuring operation has not been performed. Therefore, the standby for the T seconds is skipped, and the interface unit 105 performs a position measuring operation (steps S31 and S32).

After setting the flag N to “1” (step S33), the system control unit 120 determines whether the vehicle can reach a guided point (such as a left-turn point, or a highway entry or exit point) before the next position measuring operation in T seconds, on the basis of the current traveling speed and the position measurement interval T (step S34). In a case where the vehicle can reach a guided point (“YES” in step S34), the process moves on to step S35. In a case where the vehicle cannot reach a guided point (“NO” in step S34), the process moves on to step S36.

In step S35, the system control unit 120 changes the position measurement interval T to one second, which is the default, for example, and stands by for one second. The system control unit 120 then causes the interface unit 105 to continue the position measuring operation (steps S30 through S32). If the vehicle runs past a guided point before the next position measuring operation is performed, the position of own vehicle displayed on the display unit 112 becomes inaccurate in a case where the traveling conditions have changed with the change of the vehicle traveling direction. To cope with such a situation, the position measurement interval is shortened.

For example, the position measurement interval may be shortened when a turn of the steering wheel is greater than a predetermined angle, on the basis of the turn angle data supplied from the steering wheel turn sensor 104. Alternatively, the position measurement interval may be shortened when the vehicle deviates from the set route.

In step S36, the system control unit 120 receives the vehicle speed data and determines whether there is a change in the vehicle speed data from the previous input. If there is not a change (“NO” in step S36), the system control unit 120 stands by for T seconds, and causes the interface unit 105 to continue the position measuring operation (steps S30 through S32). If there is a change (“YES” in step S37), the process moves on to step S36.

In step S37, the system control unit 120 determines whether the input vehicle speed data indicates that the vehicle is in a stationary state. If the vehicle is not in a stationary state (“NO” in step S37), the system control unit 120 performs operations such as the traveling speed calculation and the position measurement interval setting operation (step S27 and thereafter). If the vehicle is in a stationary state (“YES” in step S37), the system control unit 120 outputs a control signal to the power supply unit 123 so as to stop the power supply (step S38).

Upon receipt of the control signal, the power supply unit 123 stops the power supply to the respective components (step S39).

As described above, according to this embodiment, the system control unit 120 performs such a control operation that the position measurement interval becomes longer as the traveling speed represented by the vehicle speed data output from the vehicle speed sensor 102 via the interface unit 105 becomes lower. Accordingly, while the position measuring operation is properly performed in accordance with the traveling situation of the vehicle, the power to be consumed by the interface unit 105 performing the position measuring operation can be reduced.

In a case where the vehicle speed data output from the vehicle speed sensor 102 indicates that the vehicle is not moving, the system control unit 120 controls the power supply unit 123 to stop the power supply to the GPS receiving unit 101, the sensors 102 through 104, and the interface unit 105. Accordingly, when there is no need to perform a position measuring operation, the GPS receiving unit 101, the sensors 102 through 104, and the interface unit 105 do not operate. Thus, the power to be consumed by position measuring operations can be further reduced.

[2.3 First Modification]

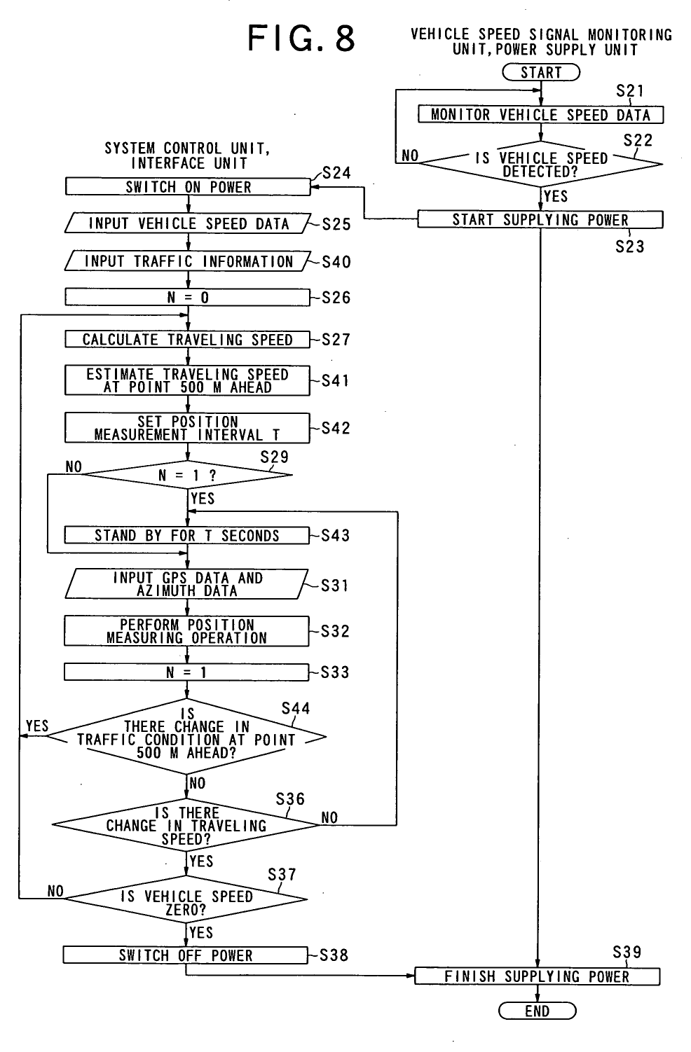

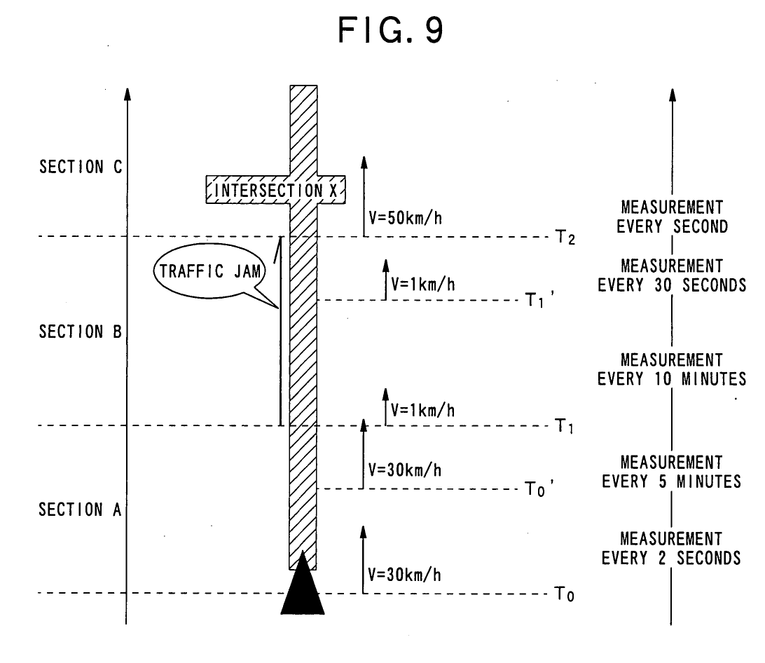

Referring now to FIGS. 8 and 9, a first modification of the second embodiment is described.

FIG. 8 is a flowchart showing an example of an operation to be performed in a navigation apparatus 100a according to the first modification of the second embodiment. In FIG. 8, the same steps as those in FIG. 7 are denoted by the same reference numerals as those in FIG. 7. FIG. 9 shows an example of position measurement intervals in the first modification of the second embodiment.

In the second embodiment described above, the position measurement interval is determined on the basis of the traveling speed of the vehicle. However, the position measurement interval may be determined on the basis of road traffic information, instead.

As shown in FIG. 8, after starting the input of a vehicle speed signal (step S25), the system control unit 120 starts the input of VICS data from the VICS data receiving unit 106, and this input is performed at 5-minute intervals, for example (step S40).

After calculating the current traveling speed of the vehicle (step S27), the system control unit 120 estimates the traveling speed of the vehicle at a spot 500 meters ahead along the route, on the basis of the current position of the vehicle, the VICS data, and the road traffic information relating to the spot 500 meters ahead (step S41).

For example, if there is a major traffic jam at the spot, the system control unit 120 estimates the traveling speed at the spot to be several kilometers per hour. If there is a speed limit, the system control unit 120 always estimates a traveling speed within the speed limit.

On the basis of the current speed (the current traveling speed of the vehicle) and the estimated speed (the estimated traveling speed), the system control unit 120 determines the position measurement interval (step S42).

More specifically, the position measurement interval is made longer if the estimated speed is lower. If the estimated speed is higher, the position measurement interval is made shorter. However, with the current speed being taken into account, the position measurement interval is determined by performing a predetermined arithmetic operation on the current speed and the estimated speed.

After a position measuring operation (steps S31 through S33), the system control unit 120 determines whether there is a change in the traffic condition at the spot 500 meters ahead (step S44). If there is not a change (“NO” in step S44), the process moves on to step S36. If there is a change (“YES” in step S44), the system control unit 120 further calculates the current traveling speed and estimates the traveling speed at a spot ahead along the route (step S27 and thereafter).

Referring now to FIG. 9, the above operation is described in greater detail.

As shown in FIG. 9, the vehicle traveling route is divided into sections A, B, and C, for ease of explanation. There is no traffic information that affects the traveling speed of the vehicle in the sections A and C, but there is a traffic jam in the section B.

At first, the vehicle runs at a speed of 30 km/h in the section A, and the estimated speed at the spot 500 meters ahead is also 30 km/h. In this case, the position measurement interval is 2 seconds.

When the vehicle reaches a spot 500 meters short of the section B, the current traveling speed remains 30 km/h, but the estimated speed becomes 1 km/h on the basis of the traffic information indicating the traffic jam in the section B. Here, the position measurement interval is 5 minutes, for example.

As described above, in a case where the current speed remains the same, and the traveling condition of the vehicle is not making a rapid change in the near future, there is no need to perform a position measuring operation frequently. Therefore, the position measurement interval is lengthened in advance, so as to reduce the amount of power to be consumed by the position measuring operation.

When the vehicle enters the section B, the current speed becomes 1 km/h, and the estimated speed also becomes 1 km/h. Here, the position measurement interval is 10 minutes.

When the vehicle reaches the spot 500 meters short of the section C, the current speed remains 1 km/h, but the estimated speed becomes 50 km/h on the basis of the traffic information indicating that there are no traffic jams in the section C. Here, the position measurement interval is 30 seconds, for example.

As described above, in a case where the current speed remains the same, but the traveling condition of the vehicle is likely to change in the near future, or in a case where the vehicle is to turn left at an intersection X, for example, the vehicle might run past the intersection before the next position measuring operation is performed, if the position measurement interval remains long. To cope with such a situation, the position measurement interval is shortened in advance.

When the vehicle enters the section C, the current speed becomes 50 km/h, and the estimated speed also becomes 50 km/h. Here, the position measurement interval is one second.

As described above, according to this embodiment, the same effects as those of the first embodiment can be achieved. In addition, a position measuring operation can be performed at more preferred intervals, since the estimated speed at a spot 500 meters ahead along the traveling route is calculated on the basis of the road traffic information as to the spot obtained from the VICS data output from the VICS data receiving unit 106, and the position measurement interval is made longer as the estimated speed becomes lower.

[2.4 Second Modification]

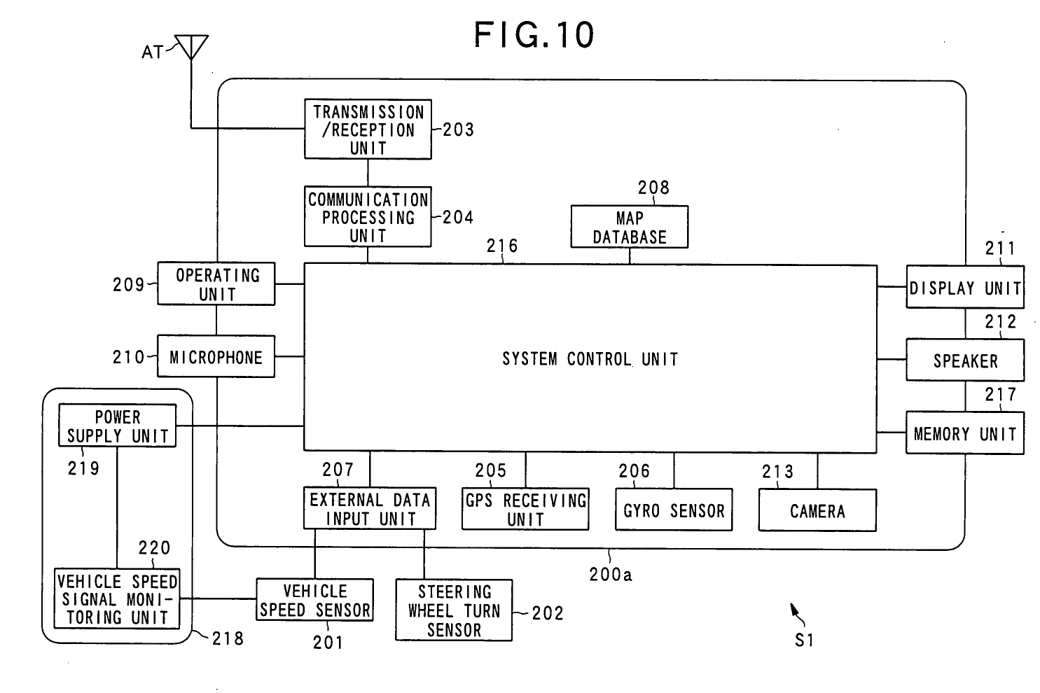

Referring now to FIG. 10, a second modification of the second embodiment is described.

FIG. 10 is a block diagram showing an example structure of a navigation system S1 according to the second modification of the second embodiment. In FIG. 10, the same components as those shown in FIG. 5 are denoted by the same reference numerals as those in FIG. 5.

As in the first embodiment, the present invention may also be applied to a navigation system utilizing a portable telephone in the second embodiment.

As shown in FIG. 10, the navigation system S1 according to this modification comprises a portable telephone 200a, a vehicle speed sensor 201, a steering wheel turn sensor 202, and a power source unit 218.

The portable telephone 200a includes a transmission/reception unit 203, a communication processing unit 204, a GPS receiving unit 205, a gyro sensor 206, an external data input unit 207, a map database 208, an operating unit 209, a microphone 210, a display unit 211, a speaker 212, a camera 213, a system control unit 216, and a memory unit 217. The system control unit 216 and the other components are connected via a system bus.

The power source unit 218 comprises a power supply unit 219 and a vehicle speed signal monitoring unit 220. The functions of those components are the same as those of the second embodiment.

The other aspects of the structure and functions of this modification are the same as those of the navigation apparatus 100a, and the operations of the navigation system S1 are also the same as those of the navigation apparatus 100a. Therefore, explanation of them is not repeated herein.

The entire disclosure of Japanese Patent Application No. 2005-328138 filed on Nov. 11, 2005 including the specification, claims, drawings and summary is incorporated herein by reference in its entirety.

What is claimed is:

1. A navigation apparatus comprising:
a detecting device that detects a movement condition of a movable body, the navigation apparatus displaying information for guiding the movable body through a route, on the basis of the detected movement condition and map data, the information being displayed on a screen;
a determining device that determines whether the current situation allows an operator to look at the screen, on the basis of at least one of the detected movement condition and the map data; and
a screen controlling device that reduces luminance of the screen or blackout the screen, when the determining device determines that the current situation does not allow the operator to look at the screen.

2. The navigation apparatus according to claim 1, wherein:
the detecting device includes a speed detecting device that detects a movement speed of the movable body and outputs speed data; and
the determining device determines that the current situation does not allow the operator to look at the screen, when the movement speed is equal to or higher than a predetermined threshold value, on the basis of the output speed data.

3. The navigation apparatus according to claim 1, wherein:
the detecting device further includes an operated amount detecting device that detects an operated amount when the movable body changes directions, and outputs operated amount data; and
the determining device determines that the current situation does not allow the operator to look at the screen, when the operated amount is equal to or larger than a predetermined threshold value, on the basis of the output operated amount data.

4. The navigation apparatus according to claim 1, wherein:
the detecting device further includes a direction change detecting device that detects one of a direction of the movable body and a directional change of the movable body, and outputs direction data; and
the determining device determines that the current situation does not allow the operator to look at the screen, when the amount of directional change is equal to or larger than a predetermined threshold value, on the basis of the output direction data.

5. The navigation apparatus according to claim 1, further comprising:
a measuring device that measures the current position of the movable body, on the basis of the detected movement condition; and
a spot data acquiring device that acquires spot data containing information relating to the spot where the movable body is currently located, on the basis of the measured current position and the map data,
wherein the determining device determines whether the current situation allows the operator to look at the screen, on the basis of the acquired spot data.

6. The navigation apparatus according to claim 5, wherein:
the spot data acquiring device acquires the spot data relating to a spot located on the traveling route of the movable body; and
the navigation apparatus further comprises a displaying device that displays information relating to the spot before the movable body reaches the spot, when the determining device determines that the current situation does not allow the operator to look at the screen when the movable body is located at the spot, on the basis of the spot data relating to the spot located on the traveling route.

7. A computer program embodied in a computer-readable medium and representing a sequence of instructions, which when executed by a computer included in a navigation apparatus that includes a detecting device that detects a movement condition of a movable body, and displays information for guiding the movable body through a route, on the basis of the detected movement condition and map data, the information being displayed on a screen, the instructions cause the computer to function as:
a determining device that determines whether the current situation allows an operator to look at the screen, on the basis of at least one of the detected movement condition and the map data; and
a screen controlling device that reduces luminance of the screen or blackout the screen, when the determining device determines that the current situation does not allow the operator to look at the screen.

8. A method for controlling a screen displaying in a navigation apparatus that includes a detecting device that detects a movement condition of a movable body, and displays information for guiding the movable body through a route, on the basis of the detected movement condition and map data, the information being displayed on the screen,
the method comprising:
a determining process of determining whether the current situation allows an operator to look at the screen, on the basis of at least one of the detected movement condition and the map data; and
a reducing process of reducing luminance of the screen or erasing the displayed information on the screen, when the current situation does not allow the operator to look at the screen.

9. A navigation apparatus comprising:
a speed detecting device that detects a movement speed of a movable body and outputs speed data;
a condition detecting device that detects a movement condition of the movable body except for the movement speed, and outputs condition data;
a measuring device that measures the current position of the movable body, on the basis of the output speed data and the output condition data; and
a measurement interval controlling device that controls a measurement interval of the measuring device in such a manner that the measurement interval becomes longer as the movement speed represented by the output speed data becomes lower,
the navigation apparatus guiding the movable body through a route, on the basis of the movement condition and the current position of the movable body, and map data.

10. The navigation apparatus according to claim 9, further comprising
a power control device that stops power supply to the condition detecting device, when the speed data output from the speed detecting device indicates that the movable body is not moving.

11. The navigation apparatus according to claim 9, further comprising:
a traffic information acquiring device that acquires traffic information at a spot on the traveling route of the movable body; and
an estimating device that estimates a movement speed of the movable body at the spot, on the basis of the acquired traffic information,
wherein the measurement interval controlling device controls the measurement interval in such a manner that the measurement interval becomes longer as the estimated movement speed becomes lower.

12. A computer program embodied in a computer-readable medium and representing a sequence of instructions, which when executed by a computer included in a navigation apparatus that includes: a speed detecting device that detects a movement speed of a movable body and outputs speed data; a condition detecting device that detects a movement condition of the movable body except for the movement speed, and outputs condition data; and a measuring device that measures the current position of the movable body, on the basis of the output speed data and the output condition data,
the navigation apparatus guiding the movable body through a route, on the basis of the movement condition and the current position of the movable body, and map data,
the instructions cause the computer to function as a measurement interval controlling device that controls a measurement interval of the measuring device in such a manner that the measurement interval becomes longer as the movement speed represented by the output speed data becomes lower.

13. A method for controlling a measurement interval in a navigation apparatus that includes: a speed detecting device that detects a movement speed of a movable body and outputs speed data; a condition detecting device that detects a movement condition of the movable body except for the movement speed, and outputs condition data; and a measuring device that measures the current position of the movable body, on the basis of the output speed data and the output condition data,
the navigation apparatus guiding the movable body through a route, on the basis of the movement condition and the current position of the movable body, and map data,
the method comprising a controlling process controlling of the measurement interval of the measuring device in such a manner that the measurement interval becomes longer as the movement speed represented by the output speed data becomes lower.
